(19) United States
(12) Patent Application Publication
(10) Pub. No.: US 2021/0148712 A1
(43) Pub. Date: May 20, 2021

(54) METHOD FOR EXTRACTING FEATURES FROM MEASURED DATA COLLECTED IN A CROWD-BASED MANNER

(71) Applicant: Robert Bosch GmbH, Stuttgart (DE)

(72) Inventors: Daniel Zaum, Sarstedt (DE); Jan Rohde, Stuttgart (DE)

(21) Appl. No.: 17/092,071

(22) Filed: Nov. 6, 2020

(30) Foreign Application Priority Data
Nov. 15, 2019 (DE) 102019217658.5

(51) Int. Cl. G01C 21/32; G01C 21/00

(52) U.S. Cl. CPC G01C 21/32; G01C 21/3878; G01C 21/3841

(57) ABSTRACT

A method for ascertaining features for digital maps, in particular for digital HAD maps, with the aid of a control unit. Ascertained measured data of a sensor of at least one vehicle are received or retrieved. The measured data are superimposed on each other according to their geographic coordinates. The superimposed measured data are linked to each other and optimized with respect to errors detected with the aid of the superimposition. The measured data are clustered and features are extracted from the formed clusters. The extracted features are provided for updating or creating digital maps. A control unit, a computer program, and a machine-readable memory medium, are also described.

### CROSS REFERENCE

The present application claims the benefit under 35 U.S.C. § 119 of German Patent Application No. DE 102019217658.5 filed on Nov. 15, 2019, which is expressly incorporated herein by reference in its entirety.

### FIELD

The present invention relates to a method for ascertaining features for digital maps, in particular for digital HAD maps, with the aid of a control unit. Moreover, the present invention relates to a control unit, a computer program, and a machine-readable memory medium.

### BACKGROUND INFORMATION

Vehicles operable in an automated manner and automated driving functions are presently reliant on up-to-date and precise maps. Such maps are usually designed as digital HAD (highly automated driving) maps and include multiple layers.

A map may include, for example, a planning layer and a localization layer. The planning layer is utilized for carrying out a trajectory planning and includes a road course and the geometry of the roads.

Due to the utilization of the localization layer, a vehicle may compare features in its environment, which have been ascertained with the aid of sensors, with virtual features in the localization plane and determine its position within the planning layer. The features may be ascertained, for example, with the aid of radar sensors.

Previously, in conventional methods, in the case of which the HAD maps including localization layers and planning layers were created from measured data from specific measuring vehicles. In order to create and store features of the localization layer, measured data from different types of sensors, such as radar sensors and camera sensors, are usually compared to one another. Such measuring trips may meet the requirements of HAD maps with respect to the up-to-dateness and the accuracy only with a high outlay.

### SUMMARY

An object of the present invention includes providing a method for ascertaining or extracting features from measured data, which is implementable with less technical complexity.

This object may be achieved in accordance with example embodiments of the present invention. Advantageous embodiments of the present invention are described herein.

According to one aspect of the present invention, a method is provided for ascertaining features for digital maps, in particular for digital HAD maps, with the aid of a control unit. In accordance with an example embodiment of the present invention, in one step, ascertained measured data of at least one sensor are received or retrieved from at least one vehicle. Preferably, measured data from multiple vehicles may be utilized, which were ascertained with the aid of a comparable sensor class. The at least one sensor may be a radar sensor, a LIDAR sensor, an ultrasonic sensor, a camera sensor, and the like. Moreover, a combination of different or identical sensors is usable.

Alternatively or additionally, measured data of multiple sensors of a vehicle may also be exclusively usable for the method.

Depending on the design of the control unit, the measured data may be already present in a memory and retrieved or may be called up from one or multiple vehicle(s). The vehicles are to be understood, in particular, as mobile units, which may also be designed as robots, watercraft, aircraft, and the like. In particular, the term vehicle is not limited to motor vehicles.

In one further step, the measured data, which were ascertained by different vehicles, are superimposed on one another according to their geographic coordinates. This step may take place via a coarse superimposition of the measured data with the aid of GPS information.

The GPS information may preferably encompass vehicle positions and vehicle orientations. The alignment of the measured data may be inaccurate due to noise and systematic errors. For this reason, the superimposed measured data are linked to one another and are optimized with respect to errors. Due to the optimization, errors detected via the superimposition are eliminated and the spatial deviations of the particular measured data sets from one another are minimized.

In one further step, the measured data of different measured data sets are combined into object clusters and features are extracted from the particular object clusters. Due to the clustering, measured data groups or consolidated measured data clouds are detected and groups or clusters are formed. Each cluster may be subsequently extracted in the form of a feature.

The extracted features may be subsequently utilized or provided during a creation or updating of planning layers and/or localization layers of HAD maps.

Due to the optimization and the clustering of the measured data sets, the feature extraction may be configured to be more efficient and a comparison with measured data of further sensor classes, such as camera sensors, may be dispensed with. In particular, due to the method, features may be ascertained and extracted solely via the use of one sensor class.

The feature extraction may reduce an object cluster or a measured data cluster, which represents multiple non-superimposed objects detected by different vehicles, to a virtual feature or a virtual object for the utilization in HAD maps. This step may be implemented, for example, by a clustering algorithm. The features may be, in particular, objects. For example, the features may be designed as traffic lights, signs, pillar structures, trees, and the like.

The optimization of the measured data sets may take place, for example, with the aid of an association of the measured data with adjacent virtual objects in the planning layer. For this association, the attributes or features of the planning layer may be retrievable in parallel to the measured data. Due to this step, a synchronization of the received measured data with existing features of the planning layer may take place.

According to one further aspect of the present invention, a control unit is provided, the control unit being configured for carrying out the method. The control unit may be, for example, a vehicle-external control unit or a vehicle-external server unit, such as a cloud system. The control unit may preferably be able to receive measured data of the at least one sensor and/or measured data from sensors.

In addition, according to one aspect of the present invention, a computer program is provided, which encompasses commands which prompt a computer or a control unit to carry out the method according to the present invention when the computer program is run by the computer or the control unit. According to one further aspect of the present invention, a machine-readable memory medium is provided, on which the computer program according to the present invention is stored.

The at least one vehicle may be operable, according to the BASt standard, in an assisted, semi-automated, highly automated and/or fully automated or driverless manner. In particular, the vehicle may be a mobile unit, which is designed as a vehicle, a robot, a drone, a watercraft, a rail vehicle, a robotaxi, an industrial robot, a commercial vehicle, a bus, an aircraft, a helicopter, and the like.

Due to the method according to the present invention and the control unit, complex processing steps for extracting features for the map creation or map updating may be simplified and accelerated. As a result, measured data collected by individual vehicles may be optimally evaluated and utilized in planning layers.

According to one exemplary embodiment of the present invention, the measured data or measured data sets ascertained by sensors of the at least two vehicles are associated and geographically aligned with respect to at least one sensor-specific localization map. Due to such an approach, a particularly precise superimposition of the particular measured data sets may be implemented, so that a particularly accurate feature extraction of attributes or features results for the planning layer.

According to one further specific embodiment of the present invention, the measured data ascertained by sensors of the at least two vehicles are geographically aligned with the aid of predefined alignment attributes. For this purpose, dedicated alignment attributes may be provided for the targeted alignment of measured data sets and utilized for the alignment and association of the measured data sets. The alignment attributes may be provided in addition to features of the planning layer, in order to allow for an alignment or a correction of measured data with respect to existing features of the planning layer. As a result, the collection of data for the planning layer of maps may be separated from an alignment step of the particular data.

According to one further exemplary embodiment of the present invention, ascertained measured data from sensors of the at least two vehicles and/or vehicle fleets are received or retrieved by a vehicle-external control unit and are processed in order to extract features. The vehicle-external control unit may be designed as a server unit or a cloud in this case. The vehicles may transmit the ascertained measured data or measured data sets to the control unit continuously or at defined time intervals. For this purpose, a communication link may be set up between the vehicles and the control unit, which is based, for example, on a transmission standard like WLAN, GSM, UMTS, LTE, 5G. Due to this measure, a crowdsourcing for measured data may be implemented, in the case of which the control unit functions as a central unit.

According to one further specific embodiment of the present invention, the ascertained measured data are received from a vehicle-side control unit and are processed in order to extract features. As a result, the processing of the measured data may take place, at least partially, in the particular vehicles that collect the measured data. The results of the feature extraction may also be transmitted to a central server unit or cloud and stored there. In particular, the steps of optimization and extraction may be carried out vehicle-externally, in order to be able to utilize a higher stationary computing power. Due to this measure, adaptations of the algorithms for the measured data association and optimization may also be centrally implemented.

According to one further exemplary embodiment of the present invention, the features are extracted in the form of objects and transmitted into a planning layer of a map. The features may be designed, in particular, as traffic lights, signs, pillar structures, trees, and the like. Preferably, objects from a cluster of measured data are identified and extracted, by which a cross-sensor class localization is also made possible.

According to one further specific embodiment of the present invention, the measured data are ascertained with the aid of radar sensors, LIDAR sensors, sound (ultrasonic) sensors, or camera sensors. As a result, the method is not limited to a certain sensor class. In particular, the features may be isolated from measured data from different sensor classes or extracted in connection with multiple sensor classes.

Preferred exemplary embodiments of the present invention are explained in greater detail below with reference to highly simplified schematic representations.

### BRIEF DESCRIPTION OF THE DRAWINGS

FIG. 1 shows a flowchart for illustrating a method according to one specific embodiment in accordance with the present invention as compared to a mapping trip.

FIGS. 2 through 4 show steps for illustrating the method according to one specific embodiment of the present invention.

FIG. 5 shows a flowchart for illustrating a method according to one further specific embodiment of the present invention.

FIG. 6 shows a flowchart for illustrating a method according to one specific embodiment of the present invention including used alignment attributes.

### DETAILED DESCRIPTION OF EXAMPLE EMBODIMENTS

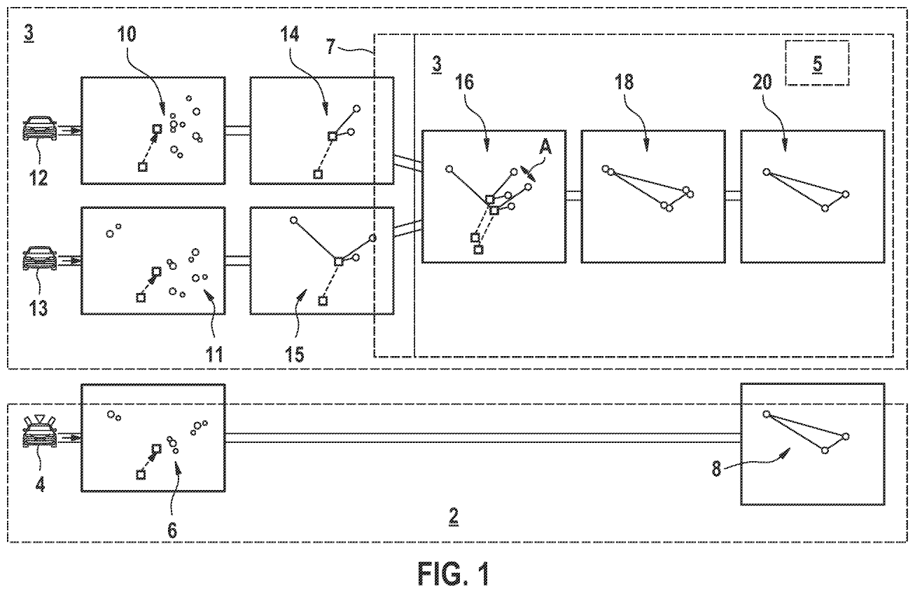

In FIG. 1, a flowchart is represented for illustrating a method 1 according to one specific embodiment as compared to a conventional mapping trip 2.

In conventional mapping trip 2, measured data 6 are collected with the aid of specific measuring vehicles 4 and subsequently processed, in order to extract features 8 for HAD maps. Conventional mapping trip 2 may be carried out in addition to method 1 according to the present invention.

In method 1, measured data or measured data sets 10, 11 are collected by multiple vehicles 12, 13. Measured data 10, 11 may be preprocessed 14, 15, for example, vehicle-internally. Measured data 10, 11 may be collected, for example, with the aid of vehicle-side radar sensors and/or LIDAR sensors.

Preprocessed measured data 14, 15 are superimposed and associated with one another in a further step 16. The alignment or superimposition of measured data 10, 11 may be inaccurate due to noise and systematic errors. As a result, measured data 10, 11 ascertained by vehicles 12, 13, respectively, deviate from one another.

Preprocessed measured data 14, 15 are transmitted to a vehicle-external control unit 3 and further processed. For this purpose, a communication link 7 may be set up between vehicles 12, 13 and control unit 3, which is based, for example, on a transmission standard like WLAN, GSM, UMTS, LTE, 5G. Due to this measure, a crowdsourcing for measured data 10, 11, 14, 15 may be implemented, in the case of which control unit 3 functions as a central unit. Control unit 3 is designed, by way of example, as a cloud, which may collect and evaluate measured data 10, 11, 14, 15 via crowdsourcing, in order to extract features 20.

Extracted features 20 may be stored, for example, in a machine-readable memory medium 5.

In one further step 18, an optimization of superimposed measured data 16 takes place. Here, for example, errors and offsets may be eliminated and, therefore, a deviation A of superimposed measured data 16 may be reduced. Thereafter, one or multiple feature(s) may be extracted 20 from corrected measured data 18.

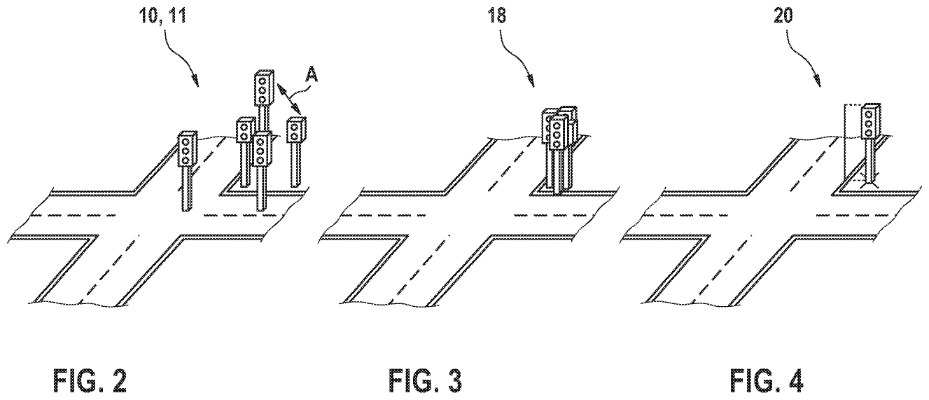

FIG. 2, FIG. 3, and FIG. 4 show, by way of example, steps for illustrating method 1 according to one specific embodiment. Ascertained or extracted feature 20 is designed as a traffic light, by way of example. The traffic light is detected with the aid of radar sensors (not represented) of vehicles 12, 13 and is evaluated in the form of measured data 10, 11 by control unit 3.

In FIG. 2, superimposed measured data 16 of different vehicles 12, 13 are simultaneously represented, in order to illustrate deviations A of measured data 16, which were ascertained by different vehicles 12, 13. Due to the lack of alignment, multiple traffic lights would be extracted as features during the creation of a planning map.

FIG. 3 shows one further step of method 1, in which superimposed measured data 16 are corrected and optimized. Due to this step, deviations A of particular measured data 16 are reduced and traffic light positions ascertained by particular vehicles 12, 13 are consolidated. The traffic light actually present once is still represented by multiple traffic lights ascertained with the aid of sensors.

FIG. 4 shows, in one further step, the extraction of a feature 20 from the consolidated cluster of measured data, which represent the traffic light. Due to this step, a feature 20 of a measured data volume is formed with the aid of clustering algorithms and, therefore, the measured data volume is reduced to a single object.

Feature 20, which is designed as a traffic light by way of example, may be subsequently utilized for the mapping of planning layers and/or localization layers of HAD maps. Due to the method, in addition, multiple features may also be extracted simultaneously or one after the other. For this purpose, measured data groups are identified, clustered, and extracted as features 20. All objects may be utilized, in general, as features 20. In particular, trees, post structures, such as streetlights or sign bridges, traffic lights, signs, and the like, may be utilized as features 20.

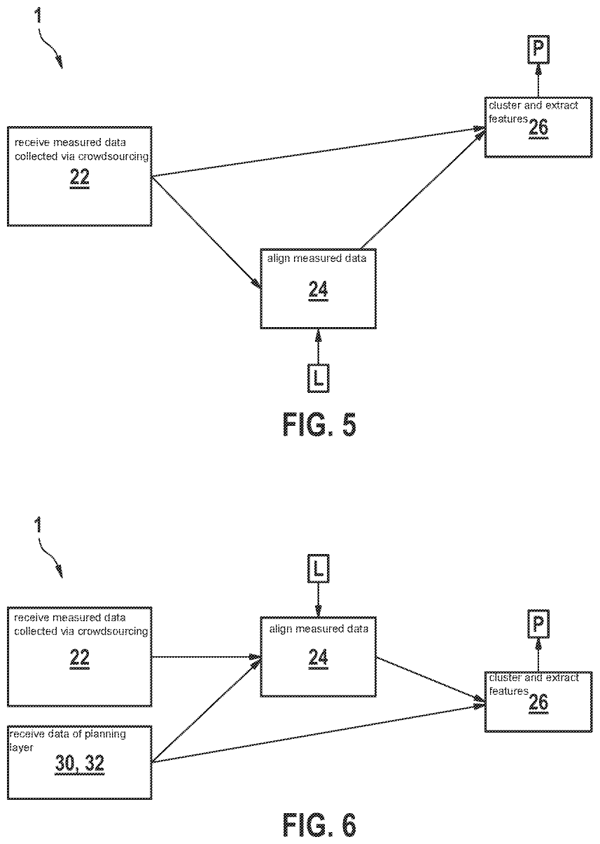

FIG. 5 shows a flowchart for illustrating method 1 according to one further specific embodiment. Measured data 22 collected via crowdsourcing are received by control unit 3. For this purpose, measured data sets of multiple vehicles are received. The vehicles may collect the measured data sets during regular trips and transmit these to control unit 3 or the cloud.

Thereafter, the measured data are aligned 24 based on a localization map or a localization layer L of an HAD map. In the process, measured data sets ascertained, in particular, by different vehicles may be aligned and superimposed in relation to one another.

Alignment 24 of the measured data on the basis of localization layer L may be subsequently utilized for a clustering and extraction 26 of features 20 for the utilization in a planning layer P.

In FIG. 6, a flowchart for illustrating a method 1 according to one further specific embodiment is represented. The utilization of alignment attributes is illustrated.

In one step, measured data 22 collected via crowdsourcing, such as measured radar data, are received from different vehicles or vehicle fleets. In parallel thereto, data 30 of planning layer P having alignment attributes 32 may be received.

The data of planning layer P as well as alignment attributes 32 may also be ascertained by vehicles with the aid of measurements or provided, for example, by map manufacturers, in order to promote a frequent and automated updating of features 20 in the maps.

Based on collected measured data 22 and alignment attributes 30, an alignment of collected measured data 22 takes place based on localization layer L. The aligned measured data are subsequently optimized and clustered. Thereafter, features 20 may be extracted 26 from the measured data.

What is claimed is:

1. A method for ascertaining features for digital HAD maps using a control unit, the method comprising the following steps:
receiving or retrieving, from at least one vehicle, ascertained measured data of at least one sensor;
superimposing the measured data on one another according to their geographic coordinates;
linking the superimposed measured data to each other and optimized with respect to errors detected using the superimposition;
clustering the superimposed measured data and extracting features from the formed clusters; and
providing the extracted features for updating or creating digital maps.

2. The method as recited in claim 1, wherein the at least one vehicle includes at least two vehicles, and wherein measured data ascertained by sensors of the at least two vehicles are associated and geographically aligned with respect to at least one sensor-specific localization map.

3. The method as recited in claim 1, wherein the at least one vehicle includes at least two vehicles, and wherein the measured data ascertained by sensors of the at least two vehicles are geographically aligned using predefined alignment attributes.

4. The method as recited in claim 1, wherein the at least one vehicle includes at least two vehicles, and wherein ascertained measured data from sensors of the at least two vehicles and/or vehicle fleets are received or retrieved by a vehicle-external control unit and are processed to extract features.

5. The method as recited in claim 1, wherein the ascertained measured data are received from a vehicle-side control unit and are processed to extract features.

6. The method as recited in claim 1, wherein the features are extracted in the form of objects and are transmitted into a planning layer of a map.

7. The method as recited in claim 1, wherein the measured data are ascertained using radar sensors, or LIDAR sensors, or sound sensors, or camera sensors.

8. A control unit configured to ascertain features for digital HAD maps using a control unit, the control unit configured to:
receive or retrieve, from at least one vehicle, ascertained measured data of at least one sensor;
superimpose the measured data on one another according to their geographic coordinates;
link the superimposed measured data to each other and optimized with respect to errors detected using the superimposition;
cluster the superimposed measured data and extracting features from the formed clusters; and
provide the extracted features for updating or creating digital maps.

9. A non-transitory machine-readable memory medium on which is stored a computer program for ascertaining features for digital HAD maps using a control unit, the computer program, when executed by a computer, causing the computer to perform the following steps:
receiving or retrieving, from at least one vehicle, ascertained measured data of at least one sensor;
superimposing the measured data on one another according to their geographic coordinates;
linking the superimposed measured data to each other and optimized with respect to errors detected using the superimposition;
clustering the superimposed measured data and extracting features from the formed clusters; and
providing the extracted features for updating or creating digital maps.
